(19) United States
(12) Patent Application Publication
(10) Pub. No.: US 2013/0257780 A1
(43) Pub. Date: Oct. 3, 2013

(54) Voice-Enabled Touchscreen User Interface

(71) Applicant: Charles Baron, Chandler, AZ (US)

(72) Inventor: Charles Baron, Chandler, AZ (US)

(21) Appl. No.: 13/992,727

(22) PCT Filed: Mar. 30, 2012
(86) PCT No.: PCT/US12/31444

§ 371 Date: Jun. 8, 2013

(51) Int. Cl. G06F 3/041; G10L 15/22

(52) U.S. Cl. CPC G06F 3/0416; G10L 15/22
USPC 345/173; 704/275

(57) ABSTRACT

An electronic device may receive a touch selection of an element on a touch screen. In response, the electronic device may enter a listening mode for a voice command spoken by a user of the device. The voice command may specify a function which the user wishes to apply to the selected element. Optionally, the listening mode may be limited a defined time period based on the touch selection. Such voice commands in combination with touch selections may facilitate user interactions with the electronic device.

### BACKGROUND

This relates generally to user interfaces for electronic devices.

In computing, a graphical user interface (GUI) is a type of user interface that enables users to control and interact with electronic devices with images rather than by typing text commands. In a device including a touch screen, a GUI may allow a user to interact with the device by touching images displayed on the touch screen. For example, the user may provide a touch input using a finger or a stylus.

### BRIEF DESCRIPTION OF THE DRAWINGS

Some embodiments are described with respect to the following figures:

FIG. 1 is a depiction of an example device in accordance with one embodiment;

FIG. 2 is a depiction of an example display in accordance with one embodiment;

FIG. 3 is a flow chart in accordance with one embodiment;

FIG. 4 is a flow chart in accordance with one embodiment;

FIG. 5 is a flow chart in accordance with one embodiment;

FIG. 6 is a schematic depiction of an electronic device in accordance with one embodiment.

### DETAILED DESCRIPTION

Conventionally, electronic devices equipped with touch screens rely on touch input for user control. Generally, a touch-based GUI enables a user to perform simple actions by touching elements displayed on the touch screen. For example, to play a media file represented by a given icon, the user may simply touch the icon to open the media file in an appropriate media player application.

However, in order to perform certain functions associated with the displayed elements, the touch-based GUI may require slow and cumbersome user actions. For example, in order to select and copy a word in a text document, the user may have to touch the word, hold the touch, and wait until a pop-up menu appears next to the word. The user may then have to look for and touch a copy command listed on the pop-up menu in order to perform the desired action. Thus, this approach requires multiple touch selections, thereby increasing the time required and the possibility of error. Further, this approach may be confusing and non-intuitive to some users.

In accordance with some embodiments, an electronic device may respond to a touch selection of an element on a touch screen by listening for a voice command from a user of the device. The voice command may specify a function which the user wishes to apply to the selected element. In some embodiments, such use of voice commands in combination with touch selections may reduce the effort and confusion required to interact with the electronic device, and may result in a more seamless, efficient, and intuitive user experience.

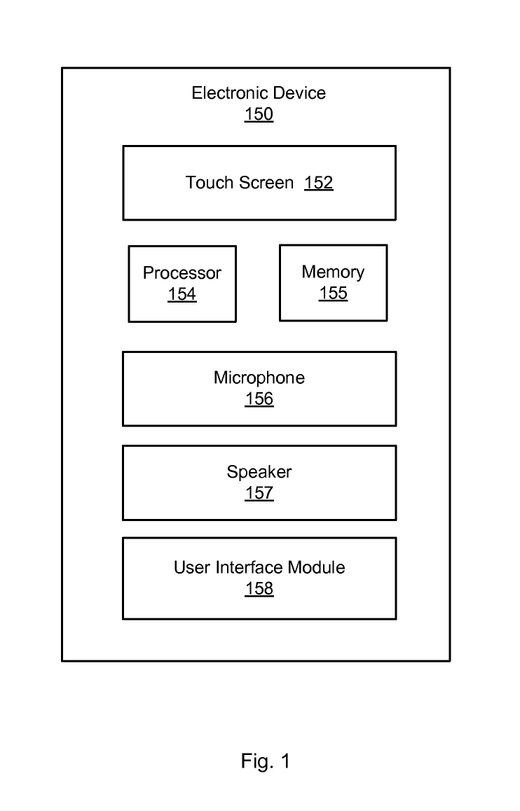

Referring to FIG. 1, an example electronic device 150 is shown in accordance to some embodiments. The electronic device 150 may be any electronic device including a touch screen. For example, the electronic device 150 may include non-portable devices (e.g., desktop computers, gaming platforms, televisions, music players, appliances, etc.) and portable devices (e.g., tablets, laptop computers, cellular telephones, smart phones, media players, e-book readers, navigation devices, handheld gaming devices, cameras, personal digital assistants, etc.).

In accordance with some embodiments, the electronic device 150 may include a touch screen 152, a processor 154, a memory device 155, a microphone 156, a speaker device 157, and a user interface module 158. The touch screen 152 may be any type of display interface including functionality to detect a touch input (e.g., a finger touch, a stylus touch, etc.). For example, the touch screen 152 may be a resistive touch screen, an acoustic touch screen, a capacitive touch screen, an infrared touch screen, an optical touch screen, a piezoelectric touch screen, etc.

In one or more embodiments, the touch screen 152 may display a GUI including any type or number of elements or objects that may be selected by touch input (referred to herein as “selectable elements”). For example, some types of selectable elements may be text elements, including any text included in documents, web pages, titles, databases, hypertext, etc. In another example, the selectable elements may be graphical elements, including any images or portions thereof, bitmapped and/or vector graphics, photograph images, video images, maps, animations, etc. In yet another example, the selectable elements may be control elements, including buttons, switches, icons, shortcuts, links, status indicators, etc. In still another example, the selectable elements may be file elements, including any icons or other representations of files such as documents, database files, music files, photograph files, video files, etc.

In one or more embodiments, the user interface module 158 may include functionality to recognize and interpret any touch selections received on the touch screen 152. For example, the user interface module 158 may analyze information about a touch selection (e.g., touch location, touch pressure, touch duration, touch movement and speed, etc.) to determine whether a user has selected any element(s) displayed on the touch screen 152.

In one or more embodiments, the user interface module 158 may be implemented in hardware, software, and/or firmware. In firmware and software embodiments, it may be implemented by computer executed instructions stored in a non-transitory computer readable medium, such as an optical, semiconductor, or magnetic storage device.

In accordance with some embodiments, the user interface module 158 may also include functionality to enter a listening mode in response to receiving a touch selection. As used herein, “listening mode” may refer to an operating mode in which the user interface module 158 interacts with the microphone 156 to listen for voice commands from a user. In some embodiments, the user interface module 158 may receive a voice command during the listening mode, and may interpret the received voice command in terms of the touch selection triggering the listening mode.

Further, in one or more embodiments, the user interface module 158 may interpret the received voice command to determine a function associated with the voice command, and may apply the determined function to the selected element (i.e., the element selected by the touch selection prior to entering the listening mode). Such functions may include any type of action or command which may be applied to a selectable element. For example, the functions associated with received voice commands may include file management functions such as save, save as, file copy, file paste, delete, move, rename, print, etc. In another example, the functions associated with received voice commands may include editing functions such as find, replace, select, cut, copy, paste, etc. In another example, the functions associated with received voice commands may include formatting functions such as bold text, italic text, underline text, fill color, border color, sharpen image, brighten image, justify, etc. In yet another example, the functions associated with received voice commands may include view functions such as zoom, pan, rotate, preview, layout, etc. In still another example, the functions associated with received voice commands may include social media functions such as share with friends, post status, send to distribution list, like/dislike, etc.

In one or more embodiments, the user interface module 158 may determine whether a received voice command is valid based on characteristics of the voice command. For example, in some embodiments, the user interface module 158 may analyze the proximity and/or position of the user speaking the voice command, whether the voice command matches or is sufficiently similar to the voices of recognized or approved users of the electronic device 150, whether the user is currently holding the device, etc.

In accordance with some embodiments, the user interface module 158 may include functionality to limit the listening mode to a defined listening time period based on the touch selection. For example, in some embodiments, the listening mode may last for predefined time period (e.g., two seconds, five seconds, ten seconds, etc.) beginning at the start or end of the touch selection. In another example, in some embodiments, the listening period may be limited to the time that the touch selection is continued (i.e., to the time that the user continually touches the selectable element 210).

In accordance with some embodiments, the user interface module 158 may include functionality to limit the listening mode based on the ambient sound level around the electronic device 150. For example, in some embodiments, the user interface module 158 may interact with the microphone 156 to determine the level and/or type of ambient sound. In the event that the ambient sound level exceeds some predefined sound level threshold, and/or if the ambient sound type is similar to spoken speech (e.g., the ambient sound includes speech or speech-like sounds), the user interface module 158 may not enter a listening mode even in the event that a touch selection is received. In some embodiments, the monitoring of ambient noise may be performed continuously (i.e., regardless of whether a touch selection has been received). Further, in one or more embodiments, the sound level threshold may be set at such a level as to avoid erroneous or unintentional voice commands caused by background noise (e.g., words spoken by someone other than the user, dialogue from a television show, etc.).

In accordance with some embodiments, the user interface module 158 may include functionality to limit voice commands and/or use of the speaker 157 based on whether the electronic device 150 is located within an excluded location. As used herein, “excluded location” may refer to a location defined as being excluded or otherwise prohibited from the use of voice commands and/or speaker functions. In one or more embodiments, any excluded locations may be specified locally (e.g., in a data structure stored in the electronic device 150), may be specified remotely (e.g., in a web site or network service), or by any other technique. For example, in some embodiments, the user interface module 158 may determine the current location of the electronic device 150 by interacting with a satellite navigation system such as the Global Positioning System (GPS). In another example, the current location may be determined based on a known location of the wireless access point (e.g., a cellular tower) being used by the electronic device 150. In still another example, the current location may be determined using proximity or triangulation to multiple wireless access points being used by the electronic device 150, and/or by any other technique or combination of techniques.

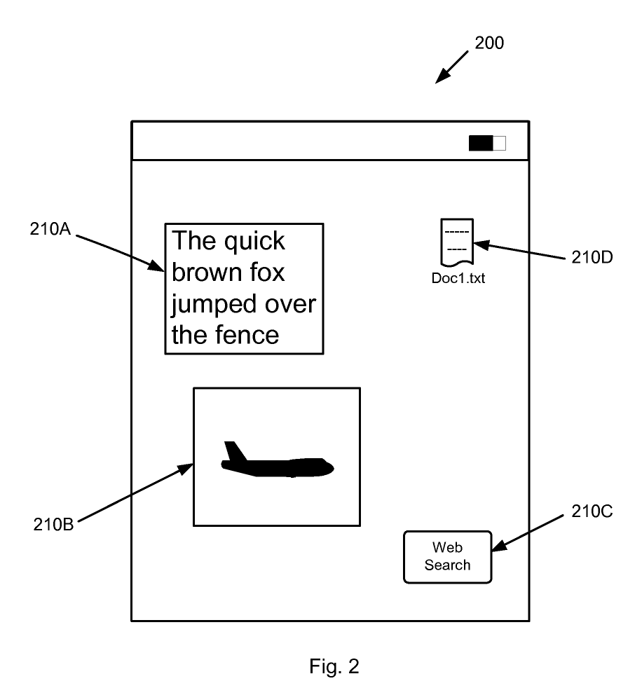

FIG. 2 shows an example of a touch screen display 200 in accordance to some embodiments. As shown, the touch screen display 200 includes a text element 210A, a graphical element 210B, a control element 210C, and a file element 210D. Assume that a user first selects the text element 210A by touching the portion of the touch screen display 200 representing the text element 210A. In response to this touch selection, the user interface module 158 may enter a listening mode for a voice command related to the text element 210A. Assume further that the user then speaks the voice command “delete,” thereby indicating that the text element 210A is to be deleted. In response to receiving the voice command “delete” associated with the touch selection, the user interface module 158 may determine that the delete function is to be applied to the text element 210A. Accordingly, the user interface module 158 may delete the text element 210A.

Note that the examples shown in FIGS. 1 and 2 are provided for the sake of example, and are not intended to limit any embodiments. For example, it is contemplated that the selectable elements 210 may be any type or number of elements that may be presented on the touch screen display 200. In another example, it is contemplated that the functions associated with voice commands may include any type of function which may be performed by any electronic devices 150 such as computers, appliances, smart phones, tablets, etc. Further, it is contemplated that specifics in the examples may be used anywhere in one or more embodiments.

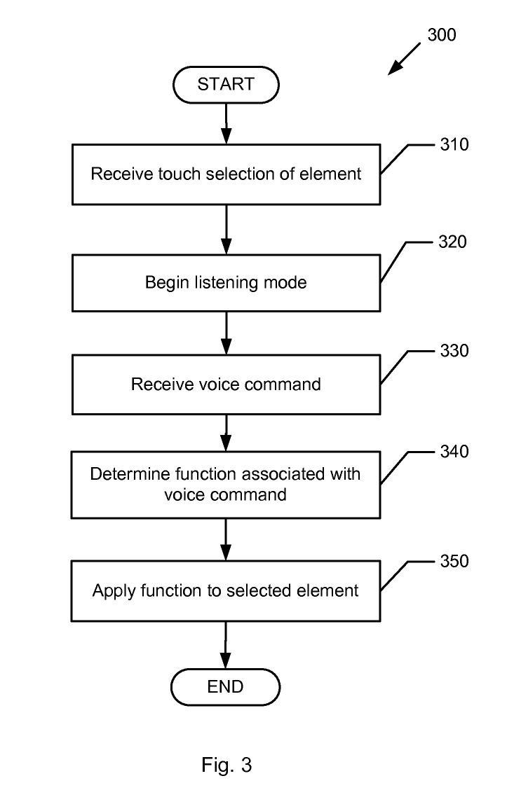

FIG. 3 shows a sequence 300 in accordance with one or more embodiments. In one embodiment, the sequence 300 may be part of the user interface module 158 shown in FIG. 1. In another embodiment, the sequence 300 may be implemented by any other component(s) of an electronic device 150. The sequence 300 may be implemented in hardware, software, and/or firmware. In firmware and software embodiments it may be implemented by computer executed instructions stored in a non-transitory computer readable medium, such as an optical, semiconductor, or magnetic storage device.

At step 310, a touch selection may be received. For example, referring to FIG. 1, the user interface module 158 may receive a touch selection of a selectable element displayed on the touch screen 152. In one or more embodiments, the user interface module 158 determine the touch selection based on, e.g., touch location, touch pressure, touch duration, touch movement and speed, etc.

At step 320, in response to receiving the touch selection, a listening mode may initiated. For example, referring to FIG. 1, the user interface module 158 may interact with the microphone 156 to listen for voice commands while in a listening mode. Optionally, in some embodiments, the user interface module 158 may limit the listening mode to a defined time period. The time period may be defined as, e.g., a given time period beginning at the start or end of the touch selection, the time duration of the touch selection, etc.

At step 330, a voice command associated with the touch selection may be received. For example, referring to FIG. 1, the user interface module 158 may determine that the microphone 156 has received a voice command while in the listening mode. In one or more embodiments, the user interface module 158 may determine whether the voice command is valid based on characteristics such the proximity and/or position of the user speaking the voice command, similarity to a known user's voice, whether the user is holding the device, etc.

At step 340, a function associated with the received voice command may be determined. For example, referring to FIG. 1, the user interface module 158 may determine whether the received voice command matches any function associated with the selected element (i.e., the element selected by the touch selection at step 310). The determined functions may include, but are not limited to, e.g., file management functions, editing functions, formatting functions, view functions, social media functions, etc.

At step 350, the determined function may be applied to the selected element. For example, referring to FIG. 2, assume that a user has touched the graphical element 210B, and that the user has spoken the voice command matching a printing function. Accordingly, in response, the user interface module 158 (shown in FIG. 1) may send the image of the graphical element 210B to an attached printer to be output on paper. After step 350, the sequence 300 ends.

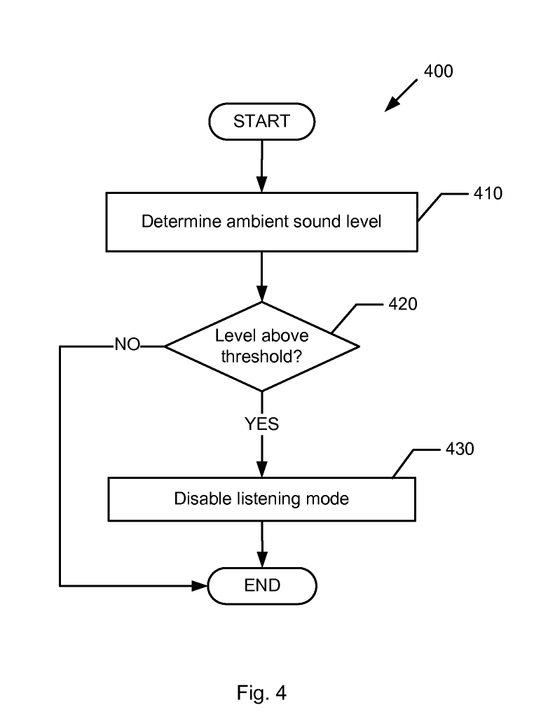

FIG. 4 shows an optional sequence 400 for disabling a listening mode based on ambient sound in accordance with some embodiments. In some embodiments, the sequence 400 may be optionally performed prior to (or in combination with) the sequence 300 shown in FIG. 3. In one embodiment, the sequence 400 may be part of the user interface module 158 shown in FIG. 1. In another embodiment, the sequence 400 may be implemented by any other component(s) of an electronic device 150. The sequence 400 may be implemented in hardware, software, and/or firmware. In firmware and software embodiments it may be implemented by computer executed instructions stored in a non-transitory computer readable medium, such as an optical, semiconductor, or magnetic storage device.

At step 410, an ambient sound level may be determined. For example, referring to FIG. 1, the user interface module 158 may interact with the microphone 156 to determine the level of ambient sound around the electronic device 150. In one or more embodiments, the user interface module 158 may also determine the type or character of ambient sound.

At step 420, a determination is made about whether the ambient sound level exceeds a predefined threshold. For example, referring to FIG. 1, the user interface module 158 may determine whether the ambient sound level exceed a predefined maximum sound level. Optionally, in some embodiments, this determination may also include determining whether the ambient sound type is similar to spoken speech (e.g., the ambient sound includes speech or speech-like sounds).

If it is determined at step 420 that the ambient sound level does not exceed the predefined threshold, then the sequence 400 ends. However, if it is determined that the ambient sound level exceeds the predefined threshold, then at step 430, a listening mode may be disabled. For example, referring to FIG. 1, the user interface module 158 may inactivate the microphone 156, or may ignore any received voice commands. After step 430, the sequence 400 ends.

In one or more embodiments, the sequence 400 may be followed by the sequence 300 shown in FIG. 3. In other embodiments, the sequence 400 may be followed by any other device or process utilizing voice commands (e.g., in any electronic device lacking a touch screen but having a voice interface). Stated differently, the sequence 400 may serve to disable listening for voice commands in any situations in which ambient sounds may cause erroneous or unintentional voice commands to be triggered. Note that the sequence 400 may be implemented either with or without using the electronic device 150 shown in FIG. 1 or the sequence 300 shown in FIG. 3.

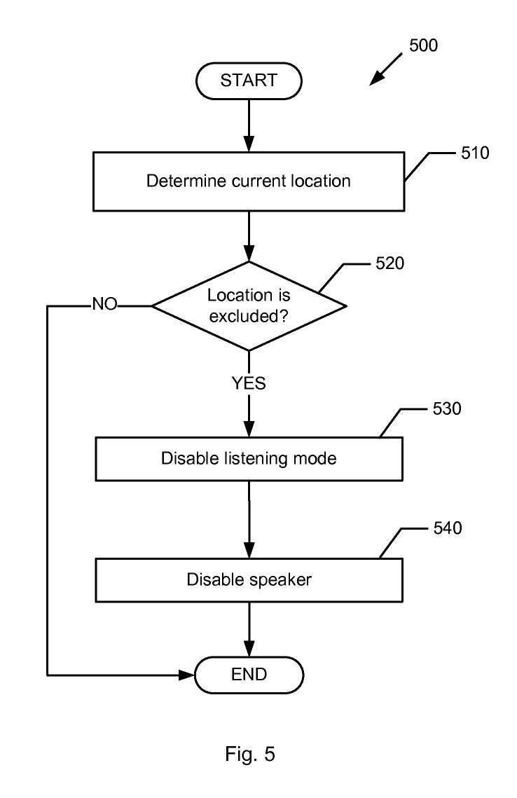

FIG. 5 shows an optional sequence 500 for disabling a listening mode and/or speaker functions based on a device location in accordance with some embodiments. In some embodiments, the sequence 500 may be optionally performed prior to (or in combination with) the sequence 300 shown in FIG. 3. In one embodiment, the sequence 500 may be part of the user interface module 158 shown in FIG. 1. In another embodiment, the sequence 500 may be implemented by any other component(s) of an electronic device 150. The sequence 500 may be implemented in hardware, software, and/or firmware. In firmware and software embodiments it may be implemented by computer executed instructions stored in a non-transitory computer readable medium, such as an optical, semiconductor, or magnetic storage device.

At step 510, the current location may be determined For example, referring to FIG. 1, the user interface module 158 may determine a current geographical location of the electronic device 150. In one or more embodiments, the user interface module 158 may determine the current location of the electronic device 150 using a satellite navigation system such as GPS, using a location of a wireless access point, using proximity or triangulation to multiple wireless access points, etc.

At step 520, a determination is made about whether the current location is excluded from the use of voice commands and/or speaker functions. For example, referring to FIG. 1, the user interface module 158 may compare the current device location to a database or listing of excluded locations. Some examples of excluded locations may include, e.g., hospitals, libraries, concert halls, schools, etc. The excluded locations may be defined using any suitable technique (e.g., street address, map coordinates, bounded areas, named locations, neighborhood name, city name, county name, etc.).

If it is determined at step 520 that the current location is not excluded, then the sequence 500 ends. However, if it is determined that the current location is excluded, then at step 530, a listening mode may be disabled. For example, referring to FIG. 1, the user interface module 158 may inactivate the microphone 156, or may ignore any received voice commands. At step 540, a speaker device may be disabled. For example, referring to FIG. 1, the user interface module 158 may inactivate the speaker 157. After step 540, the sequence 500 ends.

In one or more embodiments, the sequence 500 may be followed by the sequence 300 shown in FIG. 3. In other embodiments, the sequence 500 may be followed by any other device or process utilizing voice commands (e.g., in any electronic device lacking a touch screen but having a voice interface) and/or speaker functionality (e.g., in any electronic device having a speaker or other sound output device). Stated differently, the sequence 500 may serve to disable listening for voice commands and/or sound production in any situations in which sounds may be undesirable or prohibited (e.g., a library, a hospital, etc.). Note that the sequence 500 may be implemented either with or without using the electronic device 150 shown in FIG. 1 or the sequence 300 shown in FIG. 3.

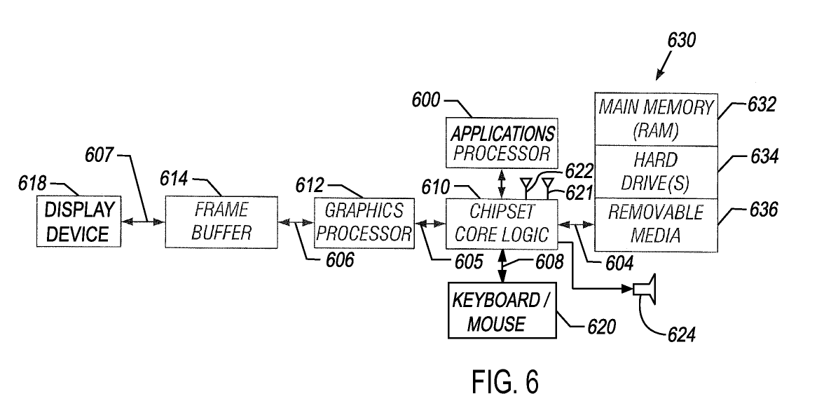

FIG. 6 depicts a computer system 630, which may be the electronic device 150 shown in FIG. 1. The computer system 630 may include a hard drive 634 and a removable storage medium 636, coupled by a bus 604 to a chipset core logic 610. A keyboard and mouse 620, or other conventional components, may be coupled to the chipset core logic via bus 608. The core logic may couple to the graphics processor 612 via a bus 605, and the applications processor 600 in one embodiment. The graphics processor 612 may also be coupled by a bus 606 to a frame buffer 614. The frame buffer 614 may be coupled by a bus 607 to a display screen 618, such as a liquid crystal display (LCD) touch screen. In one embodiment, the graphics processor 612 may be a multi-threaded, multi-core parallel processor using single instruction multiple data (SIMD) architecture.

The chipset logic 610 may include a non-volatile memory port to couple the main memory 632. Also coupled to the core logic 610 may be a radio transceiver and antenna(s) 621, 622. Speakers 624 may also be coupled through core logic 610.

The following clauses and/or examples pertain to further embodiments:

One example embodiment may be a method for controlling an electronic device, including: receiving a touch selection of a selectable element displayed on a touch screen of the electronic device; in response to receiving the touch selection, enabling the electronic device to listen for a voice command directed to the selectable element; and in response to receiving the voice command, applying a function associated with the voice command to the selectable element. The method may also include the selectable element as one of a plurality of selectable elements represented on the touch screen. The method may also include: receiving a second touch selection of a second selectable element of the plurality of selectable elements; in response to receiving the second touch selection, enabling the electronic device to listen for a second voice command directed to the second selectable element; and in response to receiving the second voice command, applying a function associated with the second voice command to the second selectable element. The method may also include receiving the voice command using a microphone of the electronic device. The method may also include, prior to enabling the electronic device to listen for the voice command, determining that an ambient sound level does not exceed a maximum noise level. The method may also include, prior to enabling the electronic device to listen for the voice command, determining that an ambient sound type is not similar to spoken speech. The method may also include, prior to enabling the electronic device to listen for the voice command, determining that the computing device is not located within an excluded location. The method may also include, after receiving the voice command, determining the function associated with the voice command. The method may also include the selectable element as a text element. The method may also include the selectable element as a graphic element. The method may also include the selectable element as a file element. The method may also include the selectable element as a control element. The method may also include the function associated with the voice command as a file management function. The method may also include the function associated with the voice command as an editing function. The method may also include the function associated with the voice command as a formatting function. The method may also include the function associated with the voice command as a view function. The method may also include the function associated with the voice command as a social media function. The method may also include enabling the electronic device to listen for the voice command directed to the selectable element as limited to a listening time period based on the touch selection. The method may also include enabling the electronic device to listen for the voice command directed to the selectable element as limited to a time duration of the touch selection.

Another example embodiment may be a method for controlling a mobile device, including: enabling a processor to selectively listen for voice commands based on an ambient sound level. The method may also include using a microphone to obtain the ambient sound level. The method may also include enabling the processor to selectively listen for voice commands further based on an ambient sound type. The method may also include enabling the processor to selectively listen for voice commands including receiving a touch selection of a selectable element displayed on a touch screen of the mobile device.

Another example embodiment may be a method for controlling a mobile device, including: enabling a processor to mute a speaker based on whether a current location of the mobile device is excluded. The method may also include determining the current location of the mobile device using a satellite navigation system. The method may also include enabling the processor to listen for voice commands based on whether the current location of the mobile device is excluded.

Another example embodiment may be a machine readable medium comprising a plurality of instructions that in response to being executed by a computing device, cause the computing device to carry out a method according to any of clauses 1 to 26.

Another example embodiment may be an apparatus arranged to perform the method according to any of the clauses 1 to 26.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

1. A method for controlling an electronic device, comprising:
receiving a touch selection of a selectable element displayed on a touch screen of the electronic device;
in response to receiving the touch selection, enabling the electronic device to listen for a voice command directed to the selectable element; and
in response to receiving the voice command, applying a function associated with the voice command to the selectable element.

2. The method of claim 1 wherein the selectable element is one of a plurality of selectable elements represented on the touch screen.

3. The method of claim 2 including:
receiving a second touch selection of a second selectable element of the plurality of selectable elements;
in response to receiving the second touch selection, enabling the electronic device to listen for a second voice command directed to the second selectable element; and
in response to receiving the second voice command, applying a function associated with the second voice command to the second selectable element.

4. The method of claim 1 including receiving the voice command using a microphone of the electronic device.

5. The method of claim 1 including, prior to enabling the electronic device to listen for the voice command, determining that an ambient sound level does not exceed a maximum noise level.

6. The method of claim 1 including, prior to enabling the electronic device to listen for the voice command, determining that an ambient sound type is not similar to spoken speech.

7. The method of claim 1 including, prior to enabling the electronic device to listen for the voice command, determining that the computing device is not located within an excluded location.

8. The method of claim 1 including, after receiving the voice command, determining the function associated with the voice command.

9. The method of claim 1 wherein the selectable element is a text element.

10. The method of claim 1 wherein the selectable element is a graphic element.

11. The method of claim 1 wherein the selectable element is a file element.

12. The method of claim 1 wherein the selectable element is a control element.

13. The method of claim 1 wherein the function associated with the voice command is a file management function.

14. The method of claim 1 wherein the function associated with the voice command is an editing function.

15. The method of claim 1 wherein the function associated with the voice command is a formatting function.

16. The method of claim 1 wherein the function associated with the voice command is a view function.

17. The method of claim 1 wherein the function associated with the voice command is a social media function.

18. The method of claim 1 wherein enabling the electronic device to listen for the voice command directed to the selectable element is limited to a listening time period based on the touch selection.

19. The method of claim 1 wherein enabling the electronic device to listen for the voice command directed to the selectable element is limited to a time duration of the touch selection.

20. A method for controlling a mobile device, comprising:
enabling a processor to selectively listen for voice commands based on an ambient sound level.

21. The method of claim 20 including using a microphone to obtain the ambient sound level.

22. The method of claim 20 wherein enabling the processor to selectively listen for voice commands is further based on an ambient sound type.

23. The method of claim 20 wherein enabling the processor to selectively listen for voice commands includes receiving a touch selection of a selectable element displayed on a touch screen of the mobile device.

24. A method for controlling a mobile device, comprising:
enabling a processor to mute a speaker based on whether a current location of the mobile device is excluded; and
determining the current location of the mobile device using a satellite navigation system.

25. (canceled)

26. The method of claim 24 including enabling the processor to listen for voice commands based on whether the current location of the mobile device is excluded.

27. At least one machine readable medium comprising a plurality of instructions that in response to being executed by a computing device, cause the computing device to carry out a method comprising:
receiving a touch selection of a selectable element displayed on a touch screen of the electronic device;
in response to receiving the touch selection, enabling the electronic device to listen for a voice command directed to the selectable element; and
in response to receiving the voice command, applying a function associated with the voice command to the selectable element.

28. An apparatus comprising:
a processor to receive a touch selection of a selectable element displayed on a touch screen of the electronic device, in response to receiving the touch selection, enable the electronic device to listen for a voice command directed to the selectable element; and in response to receiving the voice command, apply a function associated with the voice command to the selectable element.

29. The apparatus of claim 28 wherein the selectable element is one of a plurality of selectable elements represented on the touch screen.

30. The apparatus of claim 28 said processor to receive a second touch selection of a second selectable element of the plurality of selectable elements, in response to receiving the second touch selection, enable the electronic device to listen for a second voice command directed to the second selectable element, and in response to receiving the second voice command, apply a function associated with the second voice command to the second selectable element.
